(19) United States
(12) Patent Application Publication
(10) Pub. No.: US 2008/0146972 A1
(43) Pub. Date: Jun. 19, 2008

(54) CONTINUOUS PASSIVE MOTION DEVICE FOR A TOE

(76) Inventor: Pete G. Thomas, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/035,295

(22) Filed: Feb. 21, 2008

Related U.S. Application Data
(63) Continuation of application No. 11/510,116, filed on Aug. 25, 2006, now abandoned.

(51) Int. Cl. A61H 1/02; A63B 23/10; A61H 1/00

(52) U.S. Cl. 601/26; 482/79; 601/29

(57) ABSTRACT

A continuous passive motion device for providing oscillatory motion of a patient's foot to mobilize the patient's toe through a variable range of orientations about a pivot axis. The device may include a foot base having one or more hinged toe plates pivotably attached to the foot base. The foot base may be attached to a support assembly such that the foot base may be pivoted about a horizontal axis. A drive motor may be connected to the support assembly to continuously oscillate the foot plate up and down through a predetermined range of angles about the horizontal axis. The hinged top plate may be attached to the support assembly such that rotation of the foot plate will cause the toe plate to hinge in the opposite direction of the rotation of the foot and resulting in the patient's toe being oscillated through a range of flexion and extension. This range of angles of motion for the toe will be a function of the range of motion of the footplate.

### CROSS-REFERENCE TO RELATED APPLICATIONS

This application is a continuation of U.S. patent application Ser. No. 11/510,116 filed on Aug. 25, 2006, the disclosure of which is incorporated in its entirety herein by reference.

### BACKGROUND OF THE INVENTION

Studies have shown that Continuous Passive Motion therapy may help maintain range of motion (ROM) and flexibility in joints in the early postoperative and rehabilitative period after surgery or injury, when active movement might disrupt the repair process or is too painful to perform. Such passive motion involves movement of a joint without active contraction of muscle groups.

Continuous passive motion (CPM) devices have been developed to provide for passive movement of the joints, capsules, tendons, ligaments, and muscles over restricted ranges of motion and to allow the passive movements to be performed for long periods of time, while a patient is sleeping, or when no caregiver is available to administer therapy.

During CPM therapy, the joint area is secured in the CPM machine, and the machine is programmed to flex and extend the joint passively through a preselected range of motion and rate of repetition. The rate of speed and the range of motion are set using parameters determined by the clinician. The movement is slow and controlled, and the patient does not actively exert muscle force to move the joint.

CPM machines are available for many joints of the body, including the knee, ankle, jaw, hip, elbow, and shoulder and finger joints. The present invention recognizes the need to provide a CPM machine capable of mobilizing a patient's Hallux, i.e big toe, and providing continuous passive motion to the toe though a pre-selected range of motion, including flexion and extension of the toe. The present invention further provides a modular add-on for utilizing a CPM machine that delivers continuous oscillating motion to an ankle to provide continuous passive flexion and extension of the patient's big toe.

### BRIEF DESCRIPTION OF THE DRAWINGS

FIG. 1 is a side view of a continuous passive motion device for mobilizing the big toe according to the present invention.

FIG. 2 is a side view of the foot base of a continuous passive motion device when the toe plate is in a neutral position.

FIG. 3 is a side view of the foot base of a continuous passive motion device illustrating the extension of the toe plate as the foot base is rotated clockwise.

FIG. 4 is a side view of the foot base of a continuous passive motion device illustrating continued extension of the toe plate as the foot base is further rotated clockwise.

FIG. 5 is a side view of the foot base of a continuous passive motion device illustrating the flexion of the toe plate as the foot base is rotated counter-clockwise.

FIG. 6 is a top view of a foot base according to the present invention.

### DETAILED DESCRIPTION OF THE PREFERRED EMBODIMENT

The present invention utilizes an apparatus for supporting a patient's leg and foot and adjustably positioning a continuous passive motion device providing oscillatory motion of a patient's foot to mobilize the patient's toe through a variable range of orientations about a pivot axis. A preferred embodiment may include a support platform for supporting and/or moving an object, for example a foot, through a range of orientations about a horizontal pivot axis. A moveable support member, for example a foot base, is mounted to the support frame to permit pivotal movement about a first horizontal axis. For example, a rotatable arm may be attached to the support frame and the foot base may be fixedly attached to the rotatable arm. An actuator may be mounted to the support frame and the rotatable arm to create a back and forth rocking motion of the foot base along a horizontal pivot axis of the support platform, preferably transverse to the longitudinal axis of a foot held by the foot base, for obtaining dorsal and plantar flexion of the foot. The actuator is further connected to a drive motor, which is connected to a microprocessor control circuit to drive the actuator over pre-selected range within the maximum operating range for controlling the motion of the support platform about the pivot axis. The actuator may further include a control mechanism, such as a mechanical or electrical selector, for inputting the maximum up angle and maximum down angle through which the movable support may be rotated. A modular add on may then be provided to utilize the oscillatory motion of the movable foot base to drive oscillatory motion of a hinged toe plate attached to the distal end of the foot plate. The modular add-on may include a drive rod operably connected to the toe plate. The opposite end of the drive rod is pivotably connected to the support frame. As the foot plate is rotated about the first horizontal axis, the angular motion of the footplate alternately exerts a pulling or pushing force on the drive rod causing the drive rod to rotate about a horizontal axis located at the connection with the support frame. The connecting rod between the toe plate and the drive rod translates the angular motion of the drive rod into a pushing or pulling force on the hinged toe plate causing the toe plate to hinge in the opposite direction of the rotation of the foot and resulting in the patient's toe being oscillated through a range of flexion and extension.

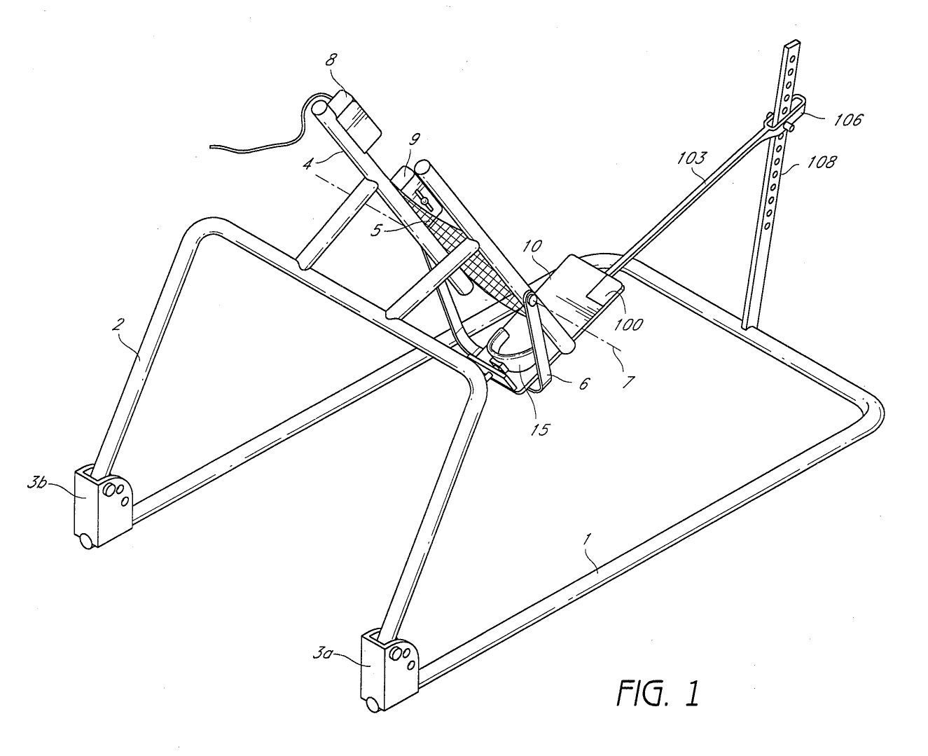

As depicted in FIG. 1, a continuous passive motion device for a toe of a foot may include a support platform, i.e. a base or frame, having proximal and distal ends. The support frame 1 may have an adjustable support leg 2 extending from the proximal end thereof. A support member 4 for holding a patient's leg is attached to the distal end of the support leg. The support leg may be adjustably secured to the support frame 1, for example via a detent connection 3a-b, such that the support leg 2 may be positioned at a variety of angles with respect to the plane of the support frame 1.

The support member 4 may further comprise first and second support bases for holding the calf and foot respectively. The first support base, or calf support 5, is fixedly secured to the support member 4 for immobilizing and supporting the patient's calf during use of the apparatus. The second support base, or foot base, 10 is pivotably secured to the support member 4 via a pivotable mounting arm 6 for holding the patient's foot. The pivotal motion of the mounting arm 6 enables pivotal motion of the patient's foot about a first horizontal pivot axis 7 located at the connection between the support member 4 and the mounting arm 6. A drive motor 8, located on the support member 4 is operably connected to the pivotable mounting arm 6 and is configured to continuously oscillate the mounting arm 6 and foot plate 10 back and forth through a predetermined range of angles. The drive motor 8 may comprise a gear motor having variable output speeds, a stepper motor, or any other suitable motor for providing oscillatory motion. The drive motor 8 may further include a control mechanism 9 for selecting the range of angles, both in an upward and downward direction relative to the resting plane of the foot plate, through which the mounting arm 6, and thereby the foot plate 10, is to be oscillated.

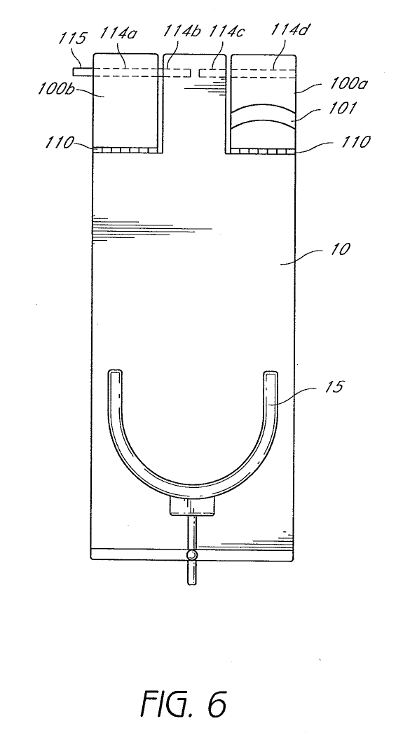

As shown in FIG. 6, the foot base 10 further includes a hinged toe plate 100 connected to the foot base 10. The foot base has a moveable heel support 15 such that when a patient's foot is placed on the foot base 10, the heel plate 15 may be adjusted to position the patient's big toe on the toe plate 100 such that a joint of the toe is pivotable about the pivot axis 110 of the hinged toe plate 100. The foot base 10 also includes an attachment means 121 on the top surface of the foot base 100 for securing the patient's foot to the foot base. In certain embodiments, the attachment means 121 may be a hook and loop strap, however it should be understood that any suitable attachment means, for example, any type of strap, groove, or pocket for receiving and securing the patient's foot to the foot plate could be used. Likewise, the toe plate 100 includes an attachment means 101 on the top surface of the toe plate 100 for securing the patient's toe to the toe plate. In certain embodiments, the attachment means 101 may be a hook and loop strap, however it should be understood that any suitable attachment means, for example, any type of strap, groove, or pocket for receiving and securing the patient's toe to the toe plate could be used.

In alternative embodiments, the toe plate may be modified, for example by increasing the width of the toe plate, to enable the continuous passive motion to be provided to lesser digits in addition to the big toe. Alternatively, the location of the toe plate on the foot base may be changed such that when the patient's foot is placed in the foot base, the big toe is positioned on the foot base, while one or more of the lesser digits rests on the hinged toe plate. Here, the joints of the one or more lesser digits may be aligned with the pivot axis of the toe plate such that continuous passive motion may be applied to the one or more lesser digits while the big toe remains fixed.

The bottom of the toe plate includes a bracket 102 for attaching a push rod 103 to the toe plate 100. The distal end of the push rod extends from the toe plate along the longitudinal axis of the toe plate. The distal end of the push rod 103 includes a pivotable connection 106, for example a hole and locking pin or any other suitable pivotable connection, for connecting the push rod to a limiting rod 108 extending from the distal end of the support platform. The limiting rod 108 is pivotably secured to the distal end of the support frame 1, for example by a hole and push pin fastener rotatably attached to the support frame 1 or any other suitable rotatable fastening mechanism, and extends vertically from the support frame 1.

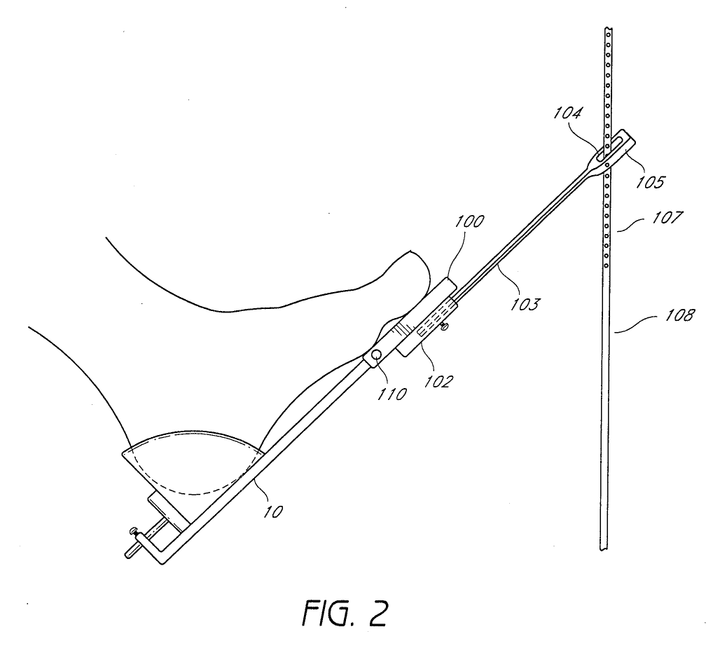

In use, when the drive motor 8 is actuated to oscillate the foot plate 10, the push rod 103 and limiting rod 108 will be engaged to indirectly drive the rotation of the toe plate 100 about its pivot axis 110 in the opposite direction of the foot plate 10. As shown in FIG. 2, the push rod 103 and limiting rod 108 are configured to be adjustably connected to one other such that a limited range of rotation is maintained between the rods. The connection between the two rods will drive the rotation of the toe plate 100 about its axis 110 as the foot plate 10 is rotated about the first horizontal axis 7. The push rod 103 and limiting rod 108 may be attached such that the range of motion for the toe plate 100 is limited to a particular range. For example, the degree of the angle of attachment between the push rod 103 and limiting rod 108 and the range of rotation about that angle will restrict the range of rotation of the toe plate. Thus, in use, as the drive motor moves the foot plate 10 cyclically through a given range of angles, the push rod 103 and limiting rod 108 assembly will exert a force on the toe plate 100 to cause the toe plate hinge to alternately flex and extend resulting in flexion and extension of the toe through a specified range of angles. This range of angles of motion for the toe will be a function of the range of motion of the footplate. The range of motion for the foot plate may be determined by drive motor 8 which may be adjusted to continuously oscillate the pivotable mounting arm 6 and foot plate 10 back and forth through a selected range of angles. Preferably, the drive motor may control foot plate 10 such that the interaction between the push and limiting rods provides a range of motion for the toe including at least 60° up deflection, or extension, and at least 20° down deflection, or flexion.

In addition, certain embodiments may include a safety shut off mechanism. The safety shut off mechanism may include a cut off switch including a pressure sensor located on the surface of toe plate and connected to the drive motor. When the pressure sensor senses too much resistance to movement of the toe plate, for example resulting from inflexibility of the patient's toe due to the initial injury or surgery, the pressure switch sends a signal to the drive motor to turn off the power and stop rotation of the foot plate, thus stopping movement of the toe. For example, the pressure sensor may be pre programmed to a specific sensitivity by the treating physician or patient by selecting a specific resistance level. When that resistance is exceeded the cut off switch will automatically shut off the drive motor. The cut off switch may further include an actuator such as an electrical sensor within the drive train that trips the drive motor power or alternatively a mechanical actuator such as a spring biased switch or any other suitable mechanism for cutting of power to the drive motor.

As depicted in FIGS. 2, in certain embodiments, the pivotable connection 106 of the push rod 103 may have an elongated hole 104 extending along the longitudinal axis, which further has a single transverse hole 105 extending through the side walls and intersecting the elongated longitudinal hole. The limiting rod 108 may be slidably inserted through the elongated longitudinal hole 104 in the push rod 103 such that a transverse hole 107 in the limiting rod 108 is aligned with the transverse hole 105 in the push rod. A locking pin may then be inserted through the transverse hole 105 in the push rod to connect the push rod 103 and the limiting rod 108. The limiting rod 108 may further include a plurality of transverse holes 107 located along its the longitudinal axis for adjustably positioning the limiting rod 108 in the push rod 103, thereby temporarily locking the connection between the rods at a limited range of angles. The choice of locking position on the limiting rod 108 thus determines the allowable range of angular movement of the toe plate 100 about its pivot axis 110.

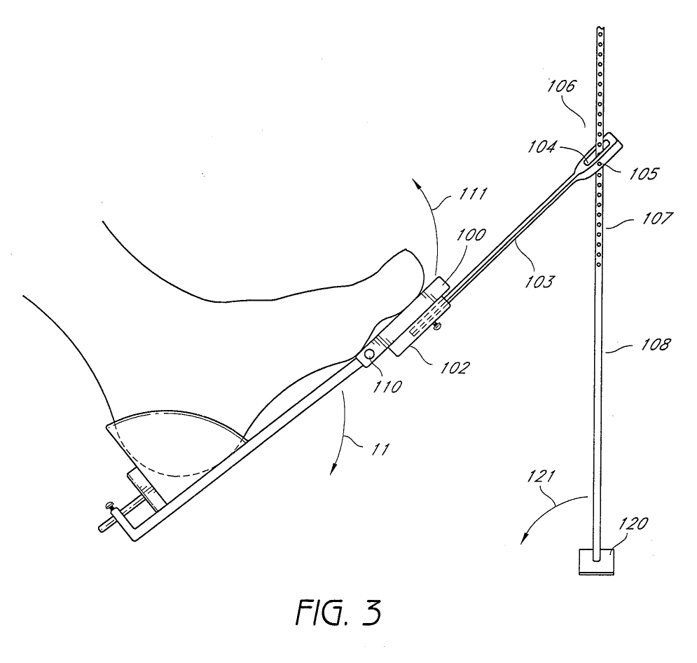

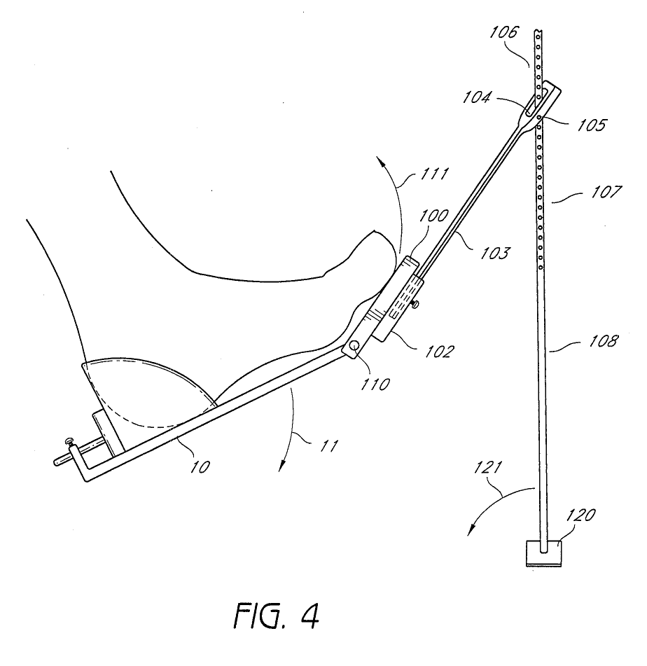

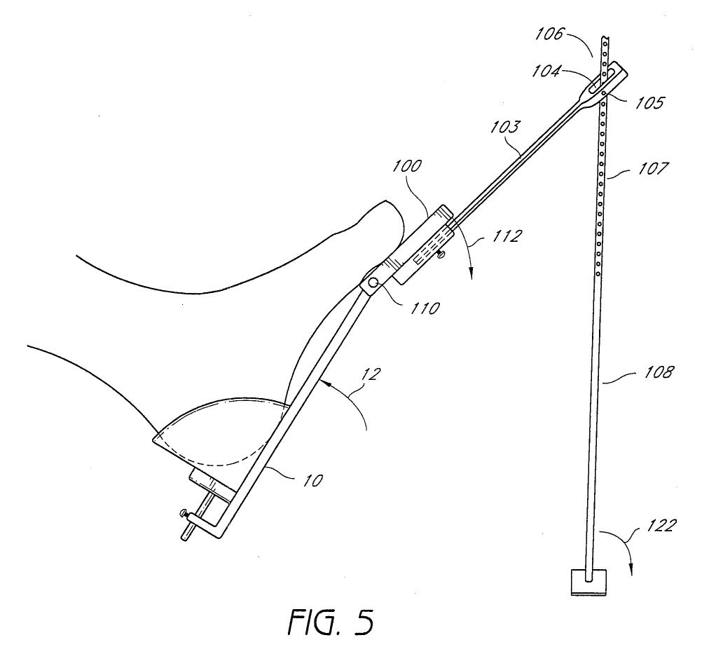

As shown in FIGS. 3-4, as the foot is being flexed, i.e. the foot plate 10 is rotated in a downward direction 11 by the action of the drive motor, the push rod 103 is pulled in a downward direction by the rotation of the foot plate 10 and the limiting rod is rotated counter clockwise 121 about the second horizontal axis 120. The attachment between the push rod 103 and limiting rod 108 assembly exerts a pushing force on the toe plate 100, thus causing the toe plate 100 to rotate about its pivot axis 110 in an upward direction 111 thus extending the attached toe. Conversely, as shown in FIG. 5, as the foot is extended, i.e. the foot plate 10 is rotated in an upward direction 12, the push rod 103 is pushed tangential to the rotation and the limiting rod is rotated clockwise 122 about the second horizontal axis 120. Here, the attachment between the push rod 103 and the limiting rod 108 results in the limiting rod 108 exerting a pulling force on the toe plate causing the toe plate to rotate about its pivot axis 110 in a downward direction 112, and, thus, flexing the attached toe. Continued rotating motion of the patient's foot by the drive motor thus results in continuous flexion and extention of the patient's toe over a predetermined range of angles. The range of angles for motion of the toe is determined by selecting the range rotation of the footpad 10 on the control settings for the drive motor. In addition, the range of extention and flexion of the toe can be determined by adjusting the angle of attachment between the push rod 103 and the limiting rod 108.

In an alternative embodiment, as depicted in FIG. 6, the foot plate 10 may further include a second hinged toe plate 100b, on the opposite side of the foot plate such that the same apparatus may be alternatively used to mobilize either the right or the left toe of a patient. In such an embodiment, the toe plates 100a-b may further include a locking mechanism for fixedly fastening the toe plate 100 to the distal end foot base 10 and preventing pivotal motion of the locked toe plate when the other toe plate is being used. For example, in one embodiment, the toe bracket 102 and foot base 10 may each have a hole 114a-d extending through a horizontal axis such that the holes are aligned when the toe plate and is positioned in the plane of the foot base 10. A locking pin 115 may then be inserted through the hole in the selected toe plate and foot base to secure the toe plate in the plane of the foot base and prohibit hinging of the toe plate.

In such an embodiment, the support base includes a second mounting means for the limiting rod 108 which is positioned to align the limiting rod 108 with the second toe plate 100b. In use, depending upon which toe, left or right, is to be passively flexed and extended, the limiting rod may be inserted into the mounting means aligned with the appropriate toe bracket 102a-b. The push rod 103 may then be inserted into the bracket 102a-b on the corresponding toe plate 100a-b and connected to the limiting rod 108. The other toe bracket may be locked in a fixed position in the plane of the foot plate by inserting the locking pin 115 into holes 114a-d on the toe plate 102a-b and the foot base 10.

The continuous passive motion device described above may be provided either as an integral machine, capable of operation to provide continuous passive motion to the big toe. Alternatively, the foot plate having at least one and optimally two moveable toe supports, connectors for connecting the foot plate to a continuous passive motion device, and related linkages to drive the moveable toe support in response to motion of the foot plate by the continuous passive motion device, may be provided as an after market kit, for connection to existing continuous passive motion devices for the lower leg and/or ankle.

What is claimed is:

1. An apparatus for providing continuous passive motion to a toe, comprising:
a support frame, further comprising a base, a support leg extending therefrom and a calf support;
a foot base pivotably coupled to the support leg and capable of pivoting about a first 1 axis;
a toe plate pivotably mounted to the foot base and capable of pivoting motion about a second 1 axis;
a drive motor configured to oscillate the foot base about the first axis;
a drive assembly connected to the toe plate and configured to induce oscillatory movement in the toe plate as a function of the motion of the foot plate, wherein the oscillatory motion of the toe plate is about the second axis in the opposite direction of the oscillatory motion of the foot base.

2. An apparatus for converting a continuous passive motion machine for an ankle to provide continuous passive motion to a toe, comprising:
a foot plate having at least one moveable toe plate pivotably mounted thereon, said toe plate capable of pivoting motion about a first axis;
one or more connectors for connecting the foot plate to a continuous passive motion device; and
a drive assembly connected to the toe plate and configured to induce oscillatory movement of the toe plate about the first axis as a function of the motion of the continuous passive motion device.

3. The apparatus of claim 2, wherein the one or more connectors are configured to pivotably connect the foot plate to the continuous passive motion such that the foot plate is capable of pivoting motion about a second axis.
